(19) United States
(12) Patent Application Publication
(10) Pub. No.: US 2026/0172324 A1
(43) Pub. Date: Jun. 18, 2026

(54) COMMUNICATION METHOD

(71) Applicant: KYOCERA Corporation, Kyoto (JP)

(72) Inventor: Masato FUJISHIRO, Yokohama-shi (JP)

(73) Assignee: KYOCERA Corporation, Kyoto (JP)

(21) Appl. No.: 19/531,950

(22) Filed: Feb. 6, 2026

Related U.S. Application Data
(63) Continuation of application No. PCT/JP2024/028302, filed on Aug. 7, 2024.

(30) Foreign Application Priority Data
Aug. 8, 2023 (JP) 2023-129203

(51) Int. Cl. H04L 41/16; H04L 41/147

(52) U.S. Cl. CPC H04L 41/16; H04L 41/147

(57) ABSTRACT

A communication method performed by a user apparatus in a mobile communication system includes: receiving, from a network node, configuration information for applying inference processing using an artificial intelligence or machine learning (AI/ML) model to wireless communication with the network node; and performing the wireless communication to which the inference processing is applied, based on the configuration information. The configuration information includes a discontinuous operation configuration for discontinuously applying the inference processing. The performing of the wireless communication includes discontinuously applying the inference processing.

### RELATED APPLICATIONS

The present application is a continuation based on PCT Application No. PCT/JP2024/028302, filed on Aug. 7, 2024, which claims the benefit of Japanese Patent Application No. 2023-129203 filed on Aug. 8, 2023. The content of which is incorporated by reference herein in their entirety.

### TECHNICAL FIELD

The present disclosure relates to a communication method used in a mobile communication system.

### BACKGROUND

In recent years, in the Third Generation Partnership Project (3GPP) (registered trademark; the same applies hereinafter) that is a standardization project for mobile communication systems, studies have been being conducted on applying Artificial Intelligence (AI) or Machine Learning (ML) (also referred to as “AI/ML”) technologies to wireless communication (that is, an air interface) in mobile communication systems.

### CITATION LIST

### Non-Patent Literature

Non-Patent Document 1: 3GPP Technical Report: TR 38.843 V0.1.0 (2023-05), “Study on Artificial Intelligence (AI)/Machine Learning (ML) for NR Air Interface (Release 18)”

### SUMMARY

A communication method according to a first aspect is a method performed by a user apparatus in a mobile communication system. The communication method includes: receiving, from a network node, configuration information for applying inference processing using an artificial intelligence or machine learning (AI/ML) model to wireless communication with the network node; and performing the wireless communication to which the inference processing is applied, based on the configuration information. The configuration information includes a discontinuous operation configuration for discontinuously applying the inference processing. The performing of the wireless communication includes discontinuously applying the inference processing.

A communication method according to a second aspect is a method performed by a user apparatus in a mobile communication system. The communication method includes: receiving, from a network node, configuration information for applying inference processing using an artificial intelligence or a machine learning (AI/ML) model to wireless communication with the network node; performing the wireless communication to which the inference processing is applied, based on the configuration information; and transmitting, to the network node, AI/ML preference information indicating a preference for a configuration change for reducing a processing load of the inference processing.

### BRIEF DESCRIPTION OF THE DRAWINGS

FIG. 1 is a diagram illustrating a configuration of a mobile communication system according to an embodiment.

FIG. 2 is a diagram illustrating a configuration of a user apparatus (UE) according to the embodiment.

FIG. 3 is a diagram illustrating a configuration of a gNB (network node) according to the embodiment.

FIG. 4 is a diagram illustrating a configuration of a protocol stack of a radio interface of a user plane handling data.

FIG. 5 is a diagram illustrating a configuration of a protocol stack of a radio interface in a control plane that handles signaling (control signals).

FIG. 6 is a diagram illustrating a functional block configuration of AI/ML technologies in a mobile communication system according to the embodiment.

FIG. 7 is a diagram illustrating an example of an application scenario of the AI/ML technologies.

FIG. 8 is a diagram illustrating a first example of reducing a CSI-RS.

FIG. 9 is a diagram illustrating a second example of reducing the CSI-RS.

FIG. 10 is a diagram illustrating an overview of a UE operation in a first operation pattern according to the embodiment.

FIG. 11 is a diagram illustrating an operation example when inference processing is periodically applied in CSI prediction related to the first operation pattern according to the embodiment.

FIG. 12 is a diagram illustrating an operation flow example of a mobile communication system according to the first operation pattern according to the embodiment.

FIG. 13 is a diagram illustrating an overview of UE operation in a second operation pattern according to the embodiment.

FIG. 14 is a diagram illustrating an operation flow example of a mobile communication system according to the second operation pattern according to the embodiment.

### DESCRIPTION OF EMBODIMENTS

When a user apparatus having an AI/ML model always performs inference processing (model inference) using the AI/ML model during wireless communication with a network node, the processing load of the inference processing in the user apparatus may increase. Therefore, in the user apparatus, problems such as an increase in power consumption, an increase in delay of inference processing, and/or an increase in internal temperature may occur. Therefore, it is difficult to utilize AI/ML technologies in mobile communication systems.

The present disclosure provides utilization of AI/ML technologies in the mobile communication systems.

According to an embodiment, a mobile communication system is described with reference to the drawings. In the description of the drawings, the same or similar parts are denoted by the same or similar reference signs.

### (1) Configuration of Mobile Communication System

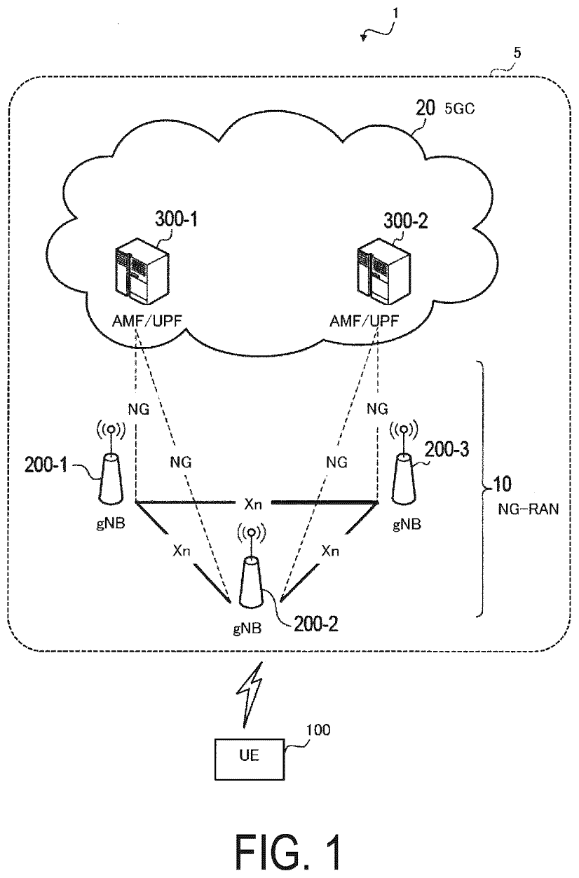

First, a configuration of a mobile communication system according to an embodiment will be described. FIG. 1 is a diagram illustrating a configuration of a mobile communication system 1 according to an embodiment. The mobile communication system 1 complies with the 5th Generation System (5GS) of the 3GPP standard. The description below takes the 5GS as an example, but a Long Term Evolution (LTE) system may be at least partially applied to the mobile communication system. A sixth generation (6G) system may be at least partially applied to the mobile communication system.

The mobile communication system 1 includes a User apparatus (UE) 100, a 5G radio access network (Next Generation Radio Access Network (NG-RAN)) 10, and a 5G Core Network (5GC) 20. Hereinafter, the NG-RAN 10 may be simply referred to as a RAN 10. The 5GC 20 may be simply referred to as a core network (CN) 20. The RAN 10 and the CN 20 configure a network 5 of the mobile communication system 1. The UE 100 performs wireless communication with the network 5.

The UE 100 is a mobile wireless communication apparatus. The UE 100 may be any apparatus as long as the UE 100 is used by a user. Examples of the UE 100 include a mobile phone terminal (which may be a smartphone) and/or a tablet terminal, a notebook PC, a communication module (which may be a communication card or a chipset), a sensor or an apparatus provided on the sensor, a vehicle or an apparatus (Vehicle UE) provided on the vehicle, and a flying object or an apparatus (Aerial UE) provided on the flying object.

The NG-RAN 10 includes base stations (referred to as “gNBs” in 5G systems) 200, which are a type of network node. The gNBs 200 are interconnected via an Xn interface which is an inter-base station interface. The gNB 200 manages one or more cells. The gNB 200 performs wireless communication with the UE 100 that has established a connection to the cell of the gNB 200. The gNB 200 has a radio resource management (RRM) function, a function of routing user data (hereinafter simply referred to as “data”), a measurement control function for mobility control and scheduling, and the like. The “cell” is used as a term representing a minimum unit of a wireless communication area. The “cell” is also used as a term representing a function or a resource for performing wireless communication with the UE 100. One cell belongs to one carrier frequency (hereinafter, simply referred to as a “frequency”).

Note that the gNB can be connected to an Evolved Packet Core (EPC) corresponding to a core network of LTE. An LTE base station can also be connected to the 5GC. The LTE base station and the gNB can be connected via an inter-base station interface.

The 5 GC 20 includes an Access and Mobility Management Function (AMF) and a User Plane Function (UPF) 300. The AMF performs various types of mobility controls and the like for the UE 100. The AMF manages mobility of the UE 100 by communicating with the UE 100 by using Non-Access Stratum (NAS) signaling. The UPF controls data transfer. The AMF and UPF are connected to the gNB 200 via an NG interface which is an interface between a base station and the core network.

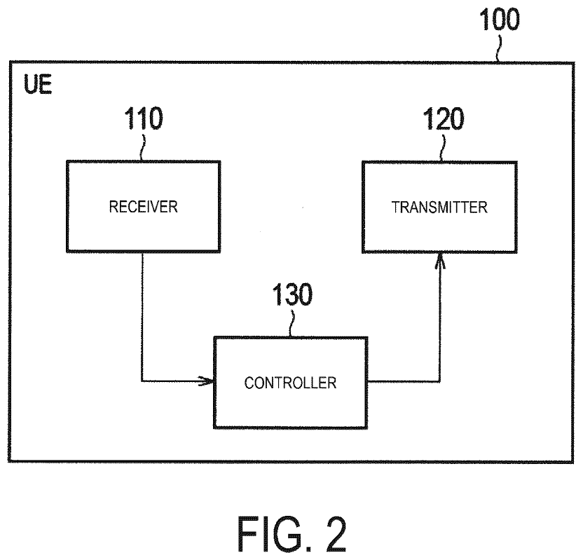

FIG. 2 is a diagram illustrating a configuration of the UE 100 (the user apparatus) according to the embodiment. The UE 100 includes a receiver 110, a transmitter 120, and a controller 130. The receiver 110 and the transmitter 120 constitute a communicator that performs wireless communication with the gNB 200. The UE 100 is an example of the communication apparatus.

The receiver 110 performs various receptions under the control of the controller 130. The receiver 110 includes an antenna and a reception device. The reception device converts a radio signal received through the antenna into a baseband signal (a reception signal) and outputs the resulting signal to the controller 130.

The transmitter 120 performs various transmissions under the control of the controller 130. The transmitter 120 includes an antenna and a transmission device. The transmission device converts a baseband signal (a transmission signal) output by the controller 130 into a radio signal and transmits the resulting signal through the antenna.

The controller 130 performs various types of control and processing in the UE 100. The operations of the UE 100 described above and to be described below may also be an operation under the control of the controller 130. The controller 130 includes at least one processor and at least one memory. The memory stores a program to be executed by the processor and information to be used for processing in the processor. The processor may include a baseband processor and a Central Processing Unit (CPU). The baseband processor performs modulation and demodulation, coding and decoding, and the like of a baseband signal. The CPU executes the program stored in the memory to thereby perform various types of processing.

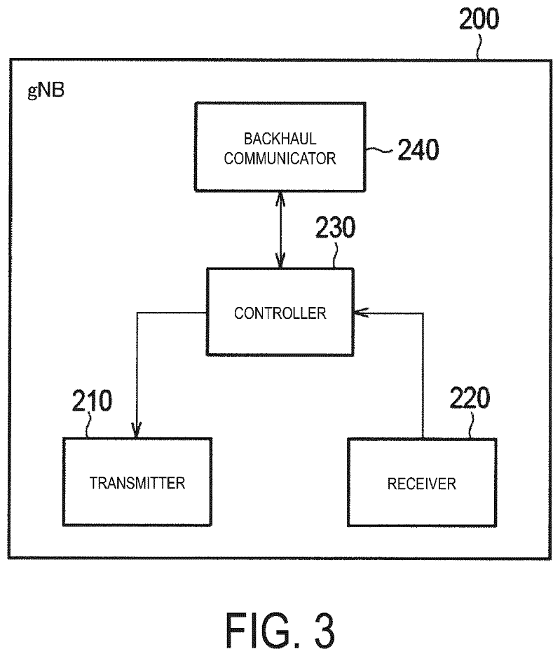

FIG. 3 is a diagram illustrating a configuration example of a gNB 200 (network node) according to the embodiment. The gNB 200 includes a transmitter 210, a receiver 220, a controller 230, and a backhaul communicator 240. The transmitter 210 and the receiver 220 constitute a communicator that performs wireless communication with the UE 100. The backhaul communicator 240 constitutes a network communicator that performs communication with the CN 20. The gNB 200 is another example of the communication apparatus.

The transmitter 210 performs various transmissions under the control of the controller 230. The transmitter 210 includes an antenna and a transmission device. The transmission device converts a baseband signal (a transmission signal) output by the controller 230 into a radio signal and transmits the resulting signal through the antenna.

The receiver 220 performs various types of reception under control of the controller 230. The receiver 220 includes an antenna and a reception device. The reception device converts a radio signal received through the antenna into a baseband signal (a reception signal) and outputs the resulting signal to the controller 230.

The controller 230 performs various types of control and processing in the gNB 200. The operations of the gNB 200 described above and below may also be performed under the control of the controller 130. The controller 230 includes at least one processor and at least one memory. The memory stores a program to be executed by the processor and information to be used for processing in the processor. The processor may include a baseband processor and a CPU. The baseband processor performs modulation and demodulation, coding and decoding, and the like of a baseband signal. The CPU executes the program stored in the memory to thereby perform various types of processing.

The backhaul communicator 240 is connected to a neighboring base station via an Xn interface which is an inter-base station interface. The backhaul communicator 240 is connected to the AMF/UPF 300 via an NG interface which is an interface between a base station and the core network. Note that the gNB 200 may include a central unit (CU) and a distributed unit (DU) (i.e., functions are divided), and the two units may be connected via an F1 interface, which is a fronthaul interface.

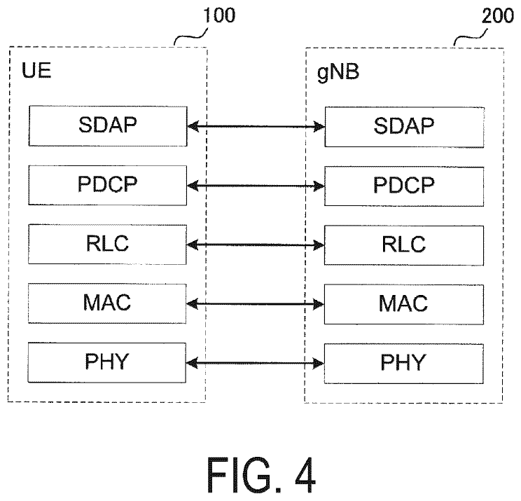

FIG. 4 is a diagram illustrating a configuration of a protocol stack of a radio interface of a user plane handling data.

The user plane radio interface protocol includes a physical (PHY) layer, a medium access control (MAC) layer, a radio link control (RLC) layer, a packet data convergence protocol (PDCP) layer, and a service data adaptation protocol (SDAP) layer.

The PHY layer performs encoding and decoding, modulation and demodulation, antenna mapping and demapping, and resource mapping and demapping. Data and control information are transmitted between the PHY layer of the UE 100 and the PHY layer of the gNB 200 via a physical channel. Note that the PHY layer of the UE 100 receives downlink control information (DCI) transmitted from the gNB 200 over a physical downlink control channel (PDCCH). Specifically, the UE 100 performs blind decoding of the PDCCH by using a radio network temporary identifier (RNTI) and acquires a successfully decoded DCI as a DCI addressed to the UE. The DCI transmitted from the gNB 200 is appended with Cyclic Redundancy Code (CRC) parity bits scrambled by the RNTI.

In NR, the UE 100 can use a bandwidth narrower than a system bandwidth (i.e., a cell bandwidth). The gNB 200 configures a bandwidth portion (BWP) consisting of consecutive Physical Resource Blocks (PRBs) for the UE 100. The UE 100 transmits and receives data and control signals in an active BWP. For example, up to four BWPs may be configurable for the UE 100. Each BWP may have a different subcarrier spacing. Frequencies of the BWPs may overlap with each other. When a plurality of BWPs are configured for the UE 100, the gNB 200 can designate which BWP to apply by controlling the downlink. By doing so, the gNB 200 dynamically adjusts the UE bandwidth depending on an amount of data traffic in the UE 100 or the like to reduce the UE power consumption.

The gNB 200 can configure, for example, up to three control resource sets (CORESETs) for each of up to four BWPs on a serving cell. The CORESET is a radio resource for control information to be received by the UE 100. Up to 12 or more CORESETs may be configured for the UE 100 on the serving cell. Each CORESET may have an index of 0 to 11 or more. A CORESET may include 6 resource blocks (PRBs) and one, two or three consecutive Orthogonal Frequency Division Multiplex (OFDM) symbols in the time domain.

The MAC layer performs priority control of data, retransmission processing through Hybrid Automatic Repeat reQuest (HARQ), a random access procedure, and the like. Data and control information are transmitted between the MAC layer of the UE 100 and the MAC layer of the gNB 200 via a transport channel. The MAC layer of the gNB 200 includes a scheduler. The scheduler decides transport formats (transport block sizes, Modulation and Coding Schemes (MCSs)) in the uplink and the downlink and resource blocks to be allocated to the UE 100.

The RLC layer transmits data to the RLC layer on the reception side by using functions of the MAC layer and the PHY layer. Data and control information are transmitted between the RLC layer of the UE 100 and the RLC layer of the gNB 200 via a logical channel.

The PDCP layer performs header compression and decompression, encryption and decryption, and the like.

The SDAP layer performs mapping between IP flows, which are units for Quality of Service (QoS) control by the core network, and radio bearers, which are units for QoS control by the Access Stratum (AS). Note that, when the RAN is connected to the EPC, the SDAP need not be provided.

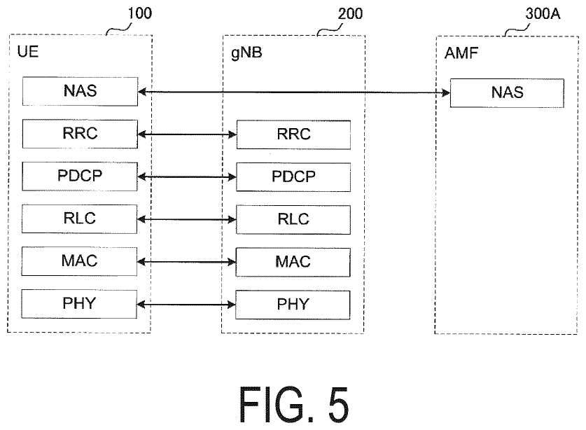

FIG. 5 is a diagram illustrating a configuration of a protocol stack of a radio interface of a control plane handling signaling (a control signal).

The protocol stack of the radio interface of the control plane includes a radio resource control (RRC) layer and a Non-Access Stratum (NAS) instead of the SDAP layer illustrated in FIG. 4.

RRC signaling for various configurations is transmitted between the RRC layer of the UE 100 and the RRC layer of the gNB 200. The RRC layer controls a logical channel, a transport channel, and a physical channel depending on establishment, re-establishment, and release of a radio bearer. When a connection (RRC connection) between the RRC of the UE 100 and the RRC of the gNB 200 is present, the UE 100 is in an RRC connected state. When no connection (RRC connection) between the RRC of the UE 100 and the RRC of the gNB 200 is present, the UE 100 is in an RRC idle state. When the connection between the RRC of the UE 100 and the RRC of the gNB 200 is suspended, the UE 100 is in an RRC inactive state.

The NAS, which is located above the RRC layer, performs session management, mobility management, and the like. NAS signaling is transmitted between the NAS of the UE 100 and the NAS of the AMF 300A. The UE 100 includes an application layer and the like other than the protocol of the radio interface. A layer lower than the NAS is referred to as an Access Stratum (AS).

### (2) Overview of AI/ML Technology

Next, an overview of AI/ML technologies will be described. In the embodiment, the mobile communication system 1 applies the AI/ML technology to wireless communication (that is, an air interface).

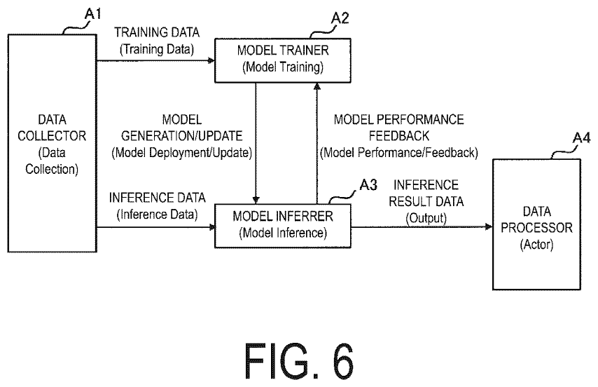

FIG. 6 is a diagram illustrating a functional block configuration of the AI/ML technology in the mobile communication system 1 according to the embodiment. The functional block configuration illustrated in FIG. 6 includes a data collector A1, a model trainer A2, a model inferrer A3, and a data processor A4.

The data collector A1 collects input data, specifically, training data and inference data, outputs the training data to the model trainer A2, and outputs the inference data to the model inferrer A3. The data collector A1 may acquire data in the apparatus in which the data collector A1 is provided, as input data. The data collector A1 may acquire, as the input data, data in another apparatus.

The model trainer A2 performs model training (also referred to as “training processing”). To be specific, the model trainer A2 optimizes parameters for the training model (hereinafter also referred to as a “model” or an “AI/ML model”) by machine learning using the training data, derives (generates or updates) a trained model, and outputs the trained model to the model inferrer A3. The model is data-driven algorithm in which a set of outputs is generated based on a set of inputs through application of the AI/ML technology. For example, considering y=ax+b,

a (slope) and b (intercept) are the parameters, and optimizing these parameters corresponds to the machine learning. In general, machine learning includes supervised learning, unsupervised learning, and reinforcement learning. The supervised learning is a method of using correct answer data for the training data. The unsupervised learning is a method of not using correct answer data for the training data. For example, in the unsupervised learning, feature points are learned from a large amount of training data, and correct answer determination (range estimation) is performed. The reinforcement learning is a method of assigning a score to an output result and learning a method of maximizing the score.

The model inferrer A3 performs model inference (also referred to as “inference processing”). To be specific, the model inferrer A3 infers an output from the inference data by using the trained model, and outputs inference result data to the data processor A4. For example, considering

y=ax+b,
x is the inference data and y corresponds to the inference result data. Note that “y=ax+b” is a model. A model in which a slope and an intercept are optimized, for example, “y=5x+3” is a trained model. Here, various techniques for the model are used, such as linear regression analysis, neural network, and decision tree analysis. The above “y=ax+b” can be considered as a kind of the linear regression analysis. The model inferrer A3 may perform model performance feedback to the model trainer A2.

The data processor A4 receives the inference result data and performs processing that utilizes the inference result data.

### (3) Example of Application Scenario of AI/ML Technology

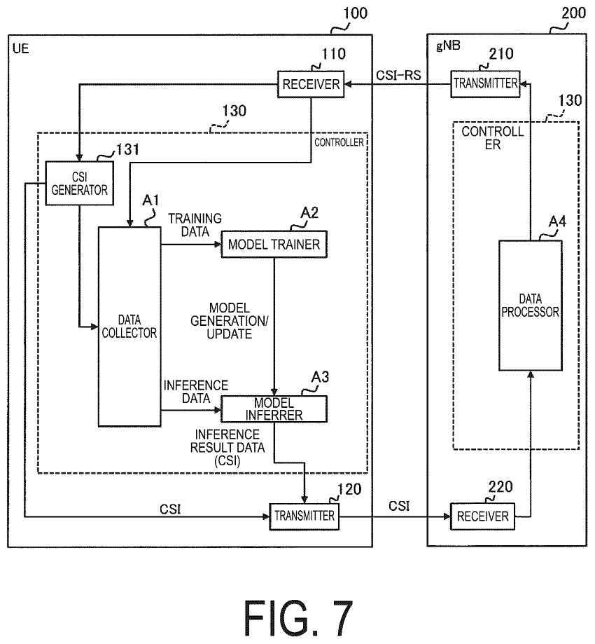

Next, an example of an application scenario of AI/ML technologies will be described. FIG. 7 is a diagram illustrating an example of an application scenario of AI/ML technologies.

In this application scenario example, the data collector A1, the model trainer A2, and the model inferrer A3 are arranged in the UE 100 (for example, the controller 130), and the data processor A4 is arranged in the gNB 200 (for example, the controller 230). In other words, model training and model inference are performed on the UE 100 side.

In this application scenario example, the AI/ML technology is introduced into channel state information (CSI) feedback from the UE 100 to the gNB 200. The CSI (CSI feedback information) transmitted (fed back) from the UE 100 to the gNB 200 is information related to a downlink channel state between the UE 100 and the gNB 200. The CSI may include at least one selected from the group consisting of a channel quality indicator (CQI), a precoding matrix indicator (PMI), and a rank indicator (RI). The gNB 200 performs, for example, downlink scheduling based on the CSI feedback from the UE 100.

The gNB 200 transmits a reference signal for the UE 100 to estimate a downlink channel state. Such a reference signal may be, for example, a CSI reference signal (CSI-RS). Such a reference signal may also be a demodulation reference signal (DMRS). Hereinafter, a description will mainly be given of an example in which the reference signal is a CSI-RS.

First, in the model training, the UE 100 (receiver 110) receives a first reference signal from the gNB 200 by using first resources. Then, the UE 100 (model trainer A2) derives a trained model for inferring CSI from the reference signal by using training data including the first reference signal. Such a first reference signal may be referred to as a full CSI-RS.

For example, the UE 100 (CSI generator 131) performs channel estimation by using the reception signal (CSI-RS) received by the receiver 110 from the gNB 200, and generates CSI. The UE 100 (transmitter 120) transmits the generated CSI to the gNB 200. The UE 100 (model trainer A2) may perform, for example, model training by using a plurality of sets of the reception signal (CSI-RS) and the CSI as the training data to derive a trained model for inferring the CSI from the reception signal (CSI-RS). The UE 100 (model trainer A2) may perform model training using the reception qualities and/or the UE moving speed as training data. The reception quality may be reference signal received power (RSRP), reference signal received quality (RSRQ), signal-to-interference-plus-noise ratio (SINR), bit error rate (BER), block error rate (BLER), analog-to-digital converter output waveform, or the like.

Second, in the model inference, the UE 100 (receiver 110) receives a second reference signal from the gNB 200 by using a second resource that is less than the first resource. Then, the UE 100 (model inferrer A3) uses the trained model to infer the CSI as the inference result data from inference data including the second reference signal. Such a second reference signal may be referred to as a partial CSI-RS or a punctured CSI-RS.

For example, the UE 100 (model inferrer A3) uses the reception signal (CSI-RS) received by the receiver 110 from the gNB 200 as the inference data, and infers the CSI from the reception signal (CSI-RS) by using the trained model. The UE 100 (transmitter 120) transmits the inferred CSI to the gNB 200. The UE 100 (model inferrer A3) may perform model inference using the reception qualities and/or the UE moving speed as inference data.

This enables the UE 100 to feed back accurate (complete) CSI to the gNB 200 from a small number of CSI-RSs (partial CSI-RSs) received from the gNB 200. For example, the gNB 200 can reduce (puncture) the CSI-RS when intended for overhead reduction. The UE 100 can cope with a situation in which a radio situation deteriorates and some CSI-RSs cannot be normally received.

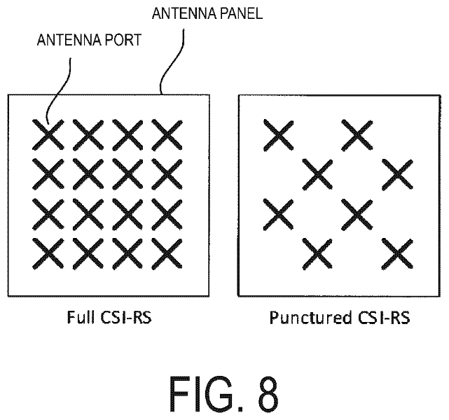

FIG. 8 is a diagram illustrating a first example of reducing CSI-RS. In the first example, the gNB 200 reduces the number of antenna ports for transmitting the CSI-RS. For example, the gNB 200 transmits the CSI-RS from all antenna ports of the antenna panel in a mode in which the UE 100 performs the model training. On the other hand, in the mode in which the UE 100 performs model inference, the gNB 200 reduces the number of antenna ports for transmitting the CSI-RSs, and transmits the CSI-RSs from half the antenna ports of the antenna panel. Note that the antenna port is an example of the resource. This can reduce the overhead, improve a utilization efficiency of the antenna ports, and give an effect of power consumption reduction.

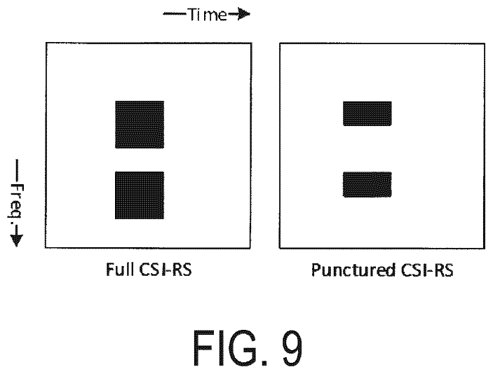

FIG. 9 is a diagram illustrating a second example of reducing CSI-RS. In the second example, the gNB 200 reduces the number of radio resources for transmitting the CSI-RSs, specifically, the number of time-frequency resources. For example, the gNB 200 transmits the CSI-RS by using a predetermined time-frequency resource in a mode in which the UE 100 performs the model training. On the other hand, in a mode in which the UE 100 performs the model inference, the gNB 200 transmits the CSI-RS using a smaller amount of time-frequency resources than predetermined time-frequency resources. This can reduce the overhead, improve a utilization efficiency of the radio resources, and give an effect of power consumption reduction.

In the following embodiments, an application scenario in which the AI/ML technology is applied to CSI feedback is assumed and described; however, other application scenarios as described in Non-Patent Document 1 may be assumed. Other application scenarios include, for example, beam management (beam estimation, overhead and latency reduction, and improvement of beam selection accuracy), UE positioning, modulation and demodulation, coding and decoding (CODEC), and packet compression.

The beam management may be beam management for SSB-based beamforming. Such beam management includes SSB selection in the RRC idle state and beam monitoring and recovery in the RRC connected state, for example. The beam management may be beam management for CSI-RS-based beamforming (precoding). Such beam management includes management for beamforming of the PDSCH in the RRC connected state, for example. The UE 100 estimates another beam (for example, beam #2) by measuring one beam (for example, beam #1), specifically, estimates a measurement result of the other beam, using the AI/ML technology.

In the UE positioning, model training and model inference may be performed using at least one selected from the group consisting of input data such as a Positioning Reference Signal (PRS), position information (latitude, longitude, and altitude) of a Global Navigation Satellite System (GNSS), RF fingerprint information (such as cell ID and its reception quality), an angle of arrival (AoA) of a reception signal, reception level/reception phase/reception time difference (OTDOA) for each antenna, roundtrip time, and reception information of short-range wireless communication such as a wireless Local Area Network (LAN). The training data may be a full PRS, for example. The UE 100 may derive position information from the full PRS, and using the full PRS and the position information as the training data, the UE 100 may generate a trained model for deriving the position information from the PRS. The training data may be a general reference signal or a PRS. When the UE 100 includes the GNSS reception device, using a reception state (a so-called RF fingerprint) of a general reference signal or a PRS and GNSS position information as the training data, the UE 100 may generate a trained model for deriving the position information from the RF fingerprint. Here, in addition to or instead of the GNSS position information, position information provided from a position server may be used.

### (4) Operation According to Embodiment

Next, in the embodiment, an operation of the mobile communication system 1 will be described.

When the UE 100 having one or more AI/ML models (learned models) always performs inference processing (model inference) using the AI/ML models during wireless communication with the gNB 200, the processing load of the inference processing in the UE 100 may increase. Therefore, in the UE 100, problems such as an increase in power consumption, an increase in delay of inference processing, and/or an increase in internal temperature may occur.

Hereinafter, a first operation pattern and a second operation pattern for solving such problems will be described. The first operation pattern and the second operation pattern may be implemented independently of each other, or the two operation patterns may be implemented in combination. In each of the following operation patterns, it is assumed that the UE 100 holds the AI/ML model (learned model) in advance.

### (4.1) First Operation Pattern

The first operation pattern is an operation pattern that enables the UE 100 to discontinuously apply the inference processing.

### (4.1.1) Overview of First Operation Pattern

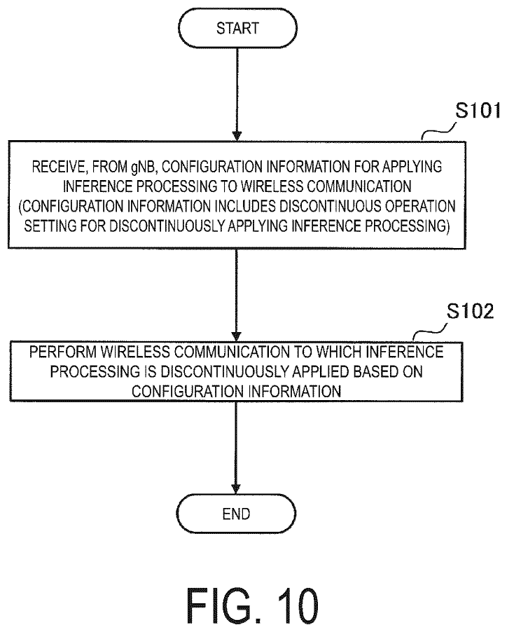

FIG. 10 is a diagram illustrating an overview of an operation of the UE 100 related to the first operation pattern.

In step S101, the UE 100 receives, from the gNB 200, configuration information for applying inference processing (model inference) using the AI/ML model to wireless communication with the gNB 200. In the first operation pattern, the configuration information includes a discontinuous operation configuration for discontinuously applying the inference processing. The discontinuous application of the inference processing may be periodic application of the inference processing. The discontinuous application of the inference processing may be applying the inference processing in a single-instance manner. The UE 100 may receive, from the gNB 200, an RRC Reconfiguration message including such configuration information. In other words, the configuration information may be RRC configuration information.

In step S102, the UE 100 performs wireless communication to which the inference processing is applied, based on the configuration information received in step S101. The UE 100 may apply inference processing to the prediction of the downlink CSI. The UE 100 may apply inference processing to beam management. The UE 100 may apply inference processing to the UE positioning.

In the first operation pattern, the UE 100 discontinuously applies the inference processing based on the discontinuous operation configuration. For example, the UE 100 may identify a timing at which the inference processing is unnecessary based on the discontinuous operation configuration, and stop (sleep) the inference processing at the identified timing.

According to such an operation, the UE 100 receives the configuration information for performing the discontinuous operation of the model inference processing. This enables the UE 100 to discontinuously apply the inference processing, and the processing load of the inference processing in the UE 100 can be reduced. Therefore, it is possible to suppress power consumption, delay of inference processing, and/or an increase in internal temperature in the UE 100.

The discontinuous operation configuration may include information indicating a timing at which the inference processing is necessary and/or information indicating a timing at which the inference processing is unnecessary. Accordingly, the UE 100 can identify an application timing at which the inference processing is applied and a non-application timing at which the inference processing is not applied.

The discontinuous operation configuration may include information related to an inference cycle when the inference processing is periodically applied. The information related to the inference cycle may include an inference start timing (Offset), an inference cycle (Cycle), and an inference duration (Duration (which may be referred to as “Periodicity”)). The information related to the inference cycle may further include information indicating an inference end timing at which the periodic inference processing is ended. The information indicating an inference start timing and/or the information indicating an inference end timing may be a frame number, a subframe number, a slot number, or a symbol number indicating the end timing. The information may be a combination of two or more of these numbers.

The discontinuous operation configuration may include information related to inference timing at which the inference processing is applied in a single-instance manner. The information related to an inference timing may be a frame number, a subframe number, a slot number, or a symbol number indicating the inference timing. The information may be a combination of two or more of these numbers.

The configuration information may include identification information for identifying an AI/ML model used for the inference processing. Specifically, the configuration information may include identification information for identifying an AI/ML model to be subjected to the discontinuous operation. The identification information may be a function ID indicating a function of the AI/ML model. The identification information may be a model ID for uniquely identifying the AI/ML model.

The configuration information may be information for configuring that the inference processing is applied to prediction of the downlink CSI. For example, the configuration information may include a function ID indicating CSI prediction or a model ID of an AI/ML model for CSI prediction. In step S102, the UE 100 applies the inference processing only at a timing (application timing) at which the inference processing is necessary, and performs prediction of CSI. That is, the UE 100 predicts CSI by applying the AI/ML model for CSI prediction at the application timing. This can reduce the processing load of the inference processing for CSI prediction in the UE 100. At the non-application timing, the UE 100 performs CSI measurement similar to that in the related art at the UE 100. In this case, the gNB 200 should transmit the same CSI-RS (full CSI-RS) as the conventional one. On the other hand, in the gNB 200, at a timing (application timing) at which the inference processing is necessary, the UE 100 applies an AI/ML model, so that it is possible to simplify (for example, transmission of a punctured CSI-RS) or stop transmission of a CSI-RS to the UE 100, and save radio resources. The gNB 200 may configure the timing to stop the transmission of the CSI-RS as the timing (application timing) at which the inference processing is necessary in the UE 100.

The configuration information may be information for configuring that the inference processing is applied to beam management. For example, the configuration information may include a function ID indicating beam management or a model ID of an AI/ML model for beam management. In step S102, the UE 100 applies the inference processing only at a timing (application timing) at which the inference processing is necessary, and performs beam management. That is, the UE 100 performs beam management by applying the AI/ML model for beam management at the application timing. This can reduce the processing load of the inference processing for beam management in the UE 100. In beam management, for example, when the gNB 200 forms two beams (beam A and beam B) and transmits beam A intermittently, the gNB 200 configures, for the UE 100, the timing to stop transmitting the beam A as the timing at which the inference processing is required (application timing). The UE 100 estimates the beam A from the beam B using the AI/ML model for beam management at the configured application timing.

The configuration information may be information for configuring that the inference processing is applied to UE positioning. For example, the configuration information may include a function ID indicating UE positioning or a model ID of an AI/ML model for UE positioning. In step S102, the UE 100 applies the inference processing only at a timing (application timing) at which the inference processing is necessary, and performs the UE positioning. That is, the UE 100 performs the UE positioning by applying the AI/ML model for the UE positioning at the application timing. This can reduce the processing load of the inference processing for the UE positioning in the UE 100. In the UE positioning, when the gNB 200, for example, transmits PRS intermittently, the gNB 200 configures, for the UE 100, the timing to stop transmitting the PRS as the timing at which the inference processing is required (application timing). The UE 100 performs positioning using the AI/ML model for UE positioning at the configured application timing.

The configuration information may be information for applying the inference processing to another use case. For example, another use case may be a DRX operation using an AI/ML model. The other use case may be a mobility operation using an AI/ML model.

### (4.1.2) Example of First Operation Pattern

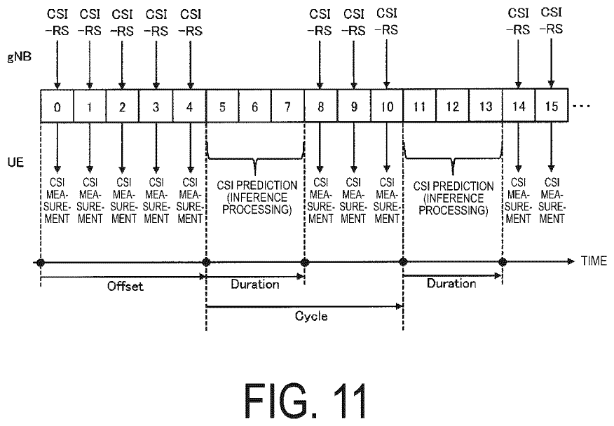

FIG. 11 is a diagram illustrating an operation example when the inference processing is periodically applied in CSI prediction related to the first operation pattern.

In FIG. 11, each rectangle represents a slot, and a number in each rectangle represents a slot number. However, instead of the processing in units of slots, processing may be performed in units of frames, subframes, or symbols. In the example of FIG. 11, the inference start timing (Offset) is set to “5”, the inference cycle (Cycle) is set to “6”, and the inference duration (Duration) is set to “3”, respectively.

In each of slots “0” to “4”, the gNB 200 transmits the CSI-RS, and the UE 100 performs the CSI measurement. The results of the CSI measurement may be transmitted from the UE 100 to the gNB 200 as CSI feedback. In the period of the slots “0” to “4”, the UE 100 may perform training processing to generate or update an AI/ML model for CSI prediction. In this period, the UE 100 stops the inference processing.

In each of slots “5” to “7”, the gNB 200 stops or reduces the transmission of the CSI-RS, and the UE 100 performs CSI prediction (inference processing) by applying the AI/ML model. The result of the CSI prediction may be transmitted from the UE 100 to the gNB 200 as the CSI feedback.

In each of slots “8” to “10”, the gNB 200 transmits the CSI-RS, and the UE 100 performs the CSI measurement. The results of the CSI measurement may be transmitted from the UE 100 to the gNB 200 as the CSI feedback. In the period of the slots “8” to “10”, the UE 100 may perform training processing and update the AI/ML model for CSI prediction. In this period, the UE 100 stops the inference processing.

In each of slots “11” to “13”, the gNB 200 stops the transmission of the CSI-RS, and the UE 100 performs CSI prediction (inference processing) by applying the AI/ML model. The result of the CSI prediction may be transmitted from the UE 100 to the gNB 200 as the CSI feedback.

### (4.1.3) Operation Flow Example of First Operation Pattern

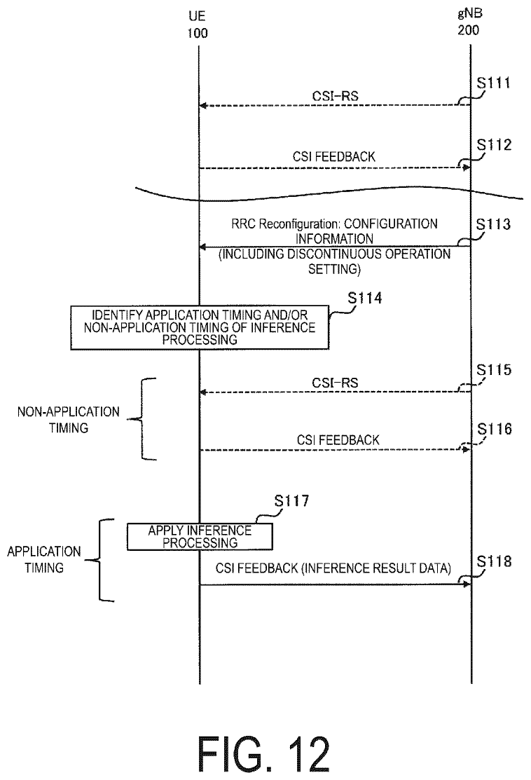

FIG. 12 is a diagram illustrating an operation flow example of the mobile communication system 1 according to the first operation pattern. In the illustrated example, the UE 100 is in an RRC connected state in a cell of the gNB 200.

In step S111, the UE 100 may receive a CSI-RS from the gNB 200 and measure the CSI. In step S112, the UE 100 may transmit the CSI feedback (feedback information) indicating the CSI measurement results of step S111 to the gNB 200. Steps S111 and S112 are conventional CSI feedback operations to which no inference processing is applied.

In step S113, the gNB 200 transmits, to the UE 100, an RRC Reconfiguration message including configuration information for configuring processing using the inference processing for the UE 100. The UE 100 receives the configuration information from the gNB 200. The gNB 200 may transmit the configuration information to the UE 100 by a MAC control element (CE) or downlink control information (DCI) instead of the RRC Reconfiguration message.

In the first operation pattern, the configuration information includes the discontinuous operation configuration as described above. The configuration information may include identification information of the AI/ML model. The configuration information may include information indicating a frequency resource (e.g., a frequency band, a BWP) to which model inference is applied. The configuration information may include information indicating a space (e.g., a tracking area, any geographic location) to which model inference is to be applied. The configuration information may include a configuration related to inference data (input data to the model). The configuration may be information indicating how many times the CSI measurement results in the past are to be input to the AI/ML model (for example, at least ten times).

In step S114, the UE 100 identifies, based on the configuration information (discontinuous operation configuration) received in step S113, a timing at which the inference processing is to be performed (application timing) and/or a timing at which the inference processing does not need to be performed (non-application timing).

In the non-application timing in steps S115 and S116, the UE 100 may perform a conventional CSI feedback operation in which the inference processing is not applied.

In the application timing in steps S117 and S118, the UE 100 performs the CSI feedback operation to which the inference processing is applied.

### (4.2) Second Operation Pattern

Differences from the first operation pattern will mainly be described for the second operation pattern. The second operation pattern is an operation pattern that enables the UE 100 to request the gNB 200 to make a configuration change for reducing a processing load of the inference processing.

### (4.2.1) Overview of Second Operation Pattern

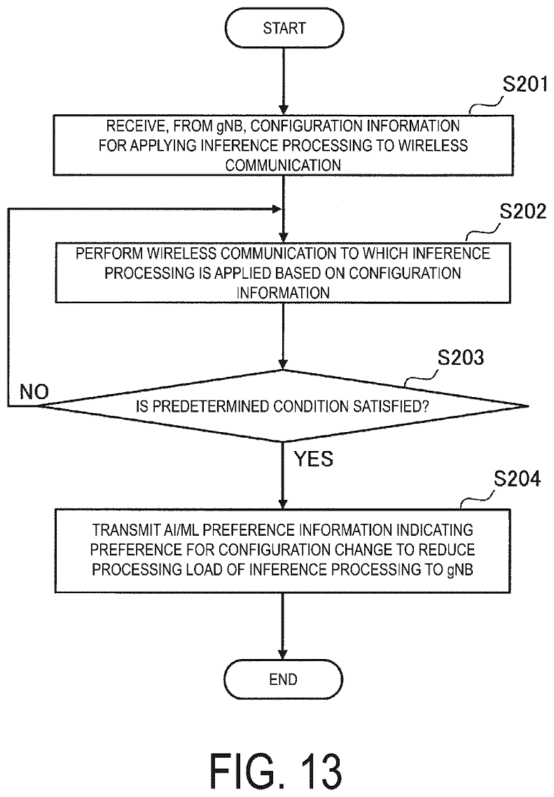

FIG. 13 is a diagram illustrating an overview of operation of the UE 100 in the second operation pattern.

In step S201, the UE 100 receives, from the gNB 200, configuration information for applying inference processing using the AI/ML model to wireless communication with the gNB 200. In the second operation pattern, the configuration information may include a discontinuous operation configuration as described above. The configuration information need not include such a configuration. The UE 100 may include, in the configuration information, identification information of an AI/ML model. The UE 100 may receive, from the gNB 200, the RRC Reconfiguration message including such configuration information. That is, the configuration information may be RRC configuration information.

In step S202, the UE 100 performs wireless communication to which the inference processing is applied, based on the configuration information received in step S201. The UE 100 may apply the inference processing to prediction of the downlink CSI. The UE 100 may apply the inference processing to the beam management. The UE 100 may apply the inference processing to the UE positioning.

In step S203, the UE 100 determines whether a predetermined condition is satisfied. The predetermined condition may be a condition that an internal overheating state in the UE 100 is detected. The predetermined condition may be a state in which power consumption of the UE 100 higher than a threshold value is detected. The predetermined condition may be a state in which a battery remaining amount of the UE 100 falls below a threshold value. The predetermined condition may further include a condition that permission to transmit the AI/ML preference information is configured by the gNB 200. When the predetermined condition is not satisfied (step S203: NO), the processing returns to step S202.

When it is determined that the predetermined condition is satisfied (step S203: YES), then in step S204, the UE 100 transmits, to the gNB 200, AI/ML preference information indicating a preference for a configuration change for reducing a processing load of the inference processing. The UE 100 may transmit, to the gNB 200, a UE Assistance Information message including the AI/ML preference information. The UE Assistance Information message is a type of RRC message.

According to such an operation, since the UE 100 can indicate, to the gNB 200, a preference for a configuration change for reducing a processing load of the inference processing, the gNB 200 can perform a configuration change for reducing the processing load of the inference processing for the UE 100. As a result, the processing load of the inference processing in the UE 100 can be reduced, and power consumption, inference delay, and/or an increase in internal temperature in the UE 100 can be suppressed.

In the second operation pattern, the AI/ML preference information may include a limit value regarding the processing load of the inference processing. In this case, the gNB 200 can perform a configuration change (reconfiguration) for the UE 100 so that the processing load of the inference processing falls within the limit value.

In the second operation pattern, the AI/ML preference information may include information indicating stopping the inference processing as a preference. In this case, the gNB 200 can perform a configuration change (reconfiguration) for stopping the inference processing for the UE 100.

### (4.2.2) Operation Flow Example of Second Operation Pattern

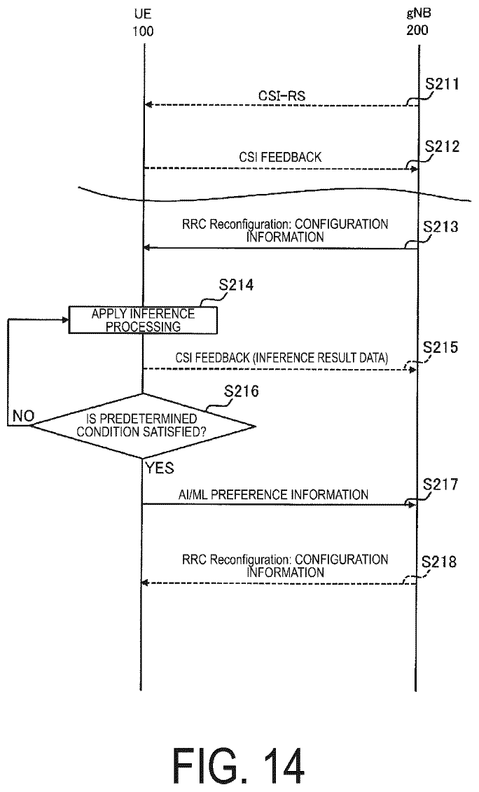

FIG. 14 is a diagram illustrating an operation flow example of the mobile communication system 1 according to the second operation pattern. In the illustrated example, the UE 100 is in an RRC connected state in a cell of the gNB 200.

In step S211, the UE 100 may receive the CSI-RS from the gNB 200 and measure CSI. In step S212, the UE 100 may transmit, to the gNB 200, the CSI feedback (feedback information) indicating the CSI measurement result of step S211. Note that steps S211 and S212 represent a conventional CSI feedback operation in which the inference processing is not applied.

In step S213, the gNB 200 transmits, to the UE 100, an RRC Reconfiguration message including configuration information for configuring processing using the inference processing for the UE 100. The UE 100 receives the configuration information from the gNB 200. Instead of the RRC Reconfiguration message, the gNB 200 may transmit the configuration information to the UE 100 by a MAC CE (Control Element) or downlink control information (DCI). When a new layer (for example, an AI/ML layer) is defined, signaling of the AI/ML layer may be used. The configuration information may be a configuration for applying the inference processing to prediction of the downlink CSI. The configuration information may be a configuration for applying inference processing to beam management. The configuration information may be a configuration for applying the inference processing to the UE positioning. In the second operation pattern, the configuration information may include a configuration indicating that the transmission of the AI/ML preference information is permitted to the UE 100. The UE 100 may be able to transmit the AI/ML preference information only when such transmission is permitted.

In step S214, the UE 100 performs wireless communication to which the inference processing is applied, based on the configuration information received in step S213. The UE 100 may apply the inference processing to prediction of the downlink CSI. The UE 100 may apply the inference processing to the beam management. The UE 100 may apply the inference processing to the UE positioning. When the inference processing is applied to prediction of the downlink CSI, in step S215, the UE 100 may transmit, to the gNB 200, predicted CSI by the inference processing as the CSI feedback.

In step S216, the UE 100 determines whether a predetermined condition for transmitting the AI/ML preference information is satisfied. When the predetermined condition is not satisfied (step S216: NO), the processing returns to step S214.

Otherwise, when it is determined that the predetermined condition is satisfied (step S216: YES), in step S217, the UE 100 transmits the AI/ML preference information to the gNB 200. The gNB 200 receives the AI/ML preference information.

For example, the UE 100 may determine that the predetermined condition is satisfied depending on detection of an internal overheating state (increase in internal temperature) of the UE 100. In this case, the UE 100 may include the AI/ML preference information in Overheating Assistance Information, which is an information element of a UE Assistance Information message, and transmit it to the gNB 200.

The UE 100 may determine that the predetermined condition is satisfied depending on detection of an excessive power consumption state (over-power-consumption), detection that its battery remaining amount falls below a certain level, or detection of a state in which a processing load is equal to or higher than a certain level (an over-processing state that affects the communication processing itself). In such cases, the UE 100 may include the AI/ML preference information in a UE Assistance Information message as an information element different from the Overheating Assistance Information.

The AI/ML preference information may include a limit value regarding the processing load of the inference processing. The AI/ML preference information may include identification information of an AI/ML model whose inference processing is to be restricted, for example, a model ID or a function ID (which may be a function name). Such AI/ML preference information may be referred to as Reduced-Model-Interference-Preference. For example, the AI/ML preference information is information indicating a maximum number (limit value) of AI/ML models for which the UE 100 performs inference processing. The AI/ML preference information may be information indicating at least one selected from the group consisting of: a limit value of the number of simultaneously executed models for model inference (inference processing), a limit value of the number of simultaneously executed models for model learning (training processing), and a limit value of the number of simultaneously executed models for inference and learning. The AI/ML preference information may include at least one limit value regarding processing capability, such as a limit value of the number of neurons or synapses of a Deep Neural Network (DNN), a limit value of FLOPS, or a limit value of memory or CPU usage (utilization).

The AI/ML preference information may include information indicating a preference for stopping (for example, deactivating) the inference processing. Such AI/ML preference information may be referred to as Model-Deactivation-Preference. The AI/ML preference information may include identification information of an AI/ML model whose execution is to be stopped, for example, a model ID or a function ID (which may be a function name).

In step S218, the gNB 200 may perform a reconfiguration for the UE 100 based on the AI/ML preference information, that is, in accordance with the preference of the UE 100. For example, the gNB 200 may transmit, to the UE 100, an RRC Reconfiguration message (or MAC CE, or the like) including configuration information for executing the inference processing within the range of the limit value regarding the processing load of the inference processing. The gNB 200 may transmit, to the UE 100, the RRC Reconfiguration message (or MAC CE, or the like) including configuration information for stopping the inference processing. When a new layer (for example, an AI/ML layer) is defined, signaling of the AI/ML layer may be used. Stopping the inference processing may be performed by releasing (deconfiguring) configuration content of step S213. The inference processing may also be stopped by deactivating the inference processing.

After transmitting the AI/ML preference information to the gNB 200 when the predetermined condition is satisfied, the UE 100 may notify the gNB 200 when the predetermined condition is no longer satisfied. For example, the notification may be performed by transmitting, to the gNB 200, AI/ML preference information that does not include the limit value and the inference stop information. The notification may alternatively be performed by transmitting, to the gNB 200, a UE Assistance Information message that does not include the AI/ML preference information.

### (5) Other Embodiments

In the above embodiments, operations in which the UE 100 intermittently performs inference processing (model inference) have mainly been described. However, in addition to or instead of such operations, the operations may be modified such that the UE 100 intermittently performs training processing (model training). In such modification examples, the term “inference processing” in the first and second operation patterns described above may be read as “training processing” or “training processing and inference processing”.

In the above embodiments, an example has mainly been described in which AI/ML-related signaling related to AI/ML technologies is an RRC message, which is signaling of the RRC layer (that is, layer 3). However, the AI/ML-related signaling may be a MAC Control Element (CE), which is signaling of the MAC layer (that is, layer 2). The AI/ML-related signaling may be downlink control information (DCI) and/or uplink control information (UCI), which is signaling of the PHY layer (that is, layer 1). The downlink AI/ML-related signaling may be UE-dedicated signaling. The downlink AI/ML-related signaling may be broadcast signaling. The AI/ML-related signaling may be signaling in a newly defined layer specializing in artificial intelligence or machine learning (for example, an AI/ML layer).

The operation flows described above can be separately and independently implemented, and also be implemented in combination of two or more of the operation flows. For example, some steps of one operation flow may be added to another operation flow or some steps of one operation flow may be replaced with some steps of another operation flow. In each flow, all steps need not be necessarily performed, and only some of the steps may be performed.

In the above-described embodiment, an example in which the base station is an NR base station (gNB) has been described, but the base station may be an LTE base station (eNB). The base station may be a relay node such as an Integrated Access and Backhaul (IAB) node. The base station may be a distributed unit (DU) of the IAB node. The user apparatus (terminal apparatus) may be a relay node such as an IAB node or a Mobile Termination (MT) of the IAB node.

That is, the UE 100 may be a terminal function unit (a type of communication module) for a base station to control a repeater that performs signal relay. Such terminal function unit is referred to as an MT. Examples of the MT include, a Network Controlled Repeater (NCR)-MT, a Reconfigurable Intelligent Surface (RIS)-MT, in addition to the IAB-MT.

The term “network node” mainly means a base station, but may also mean a core network apparatus or a part (CU, DU, or RU) of the base station. The network node may include a combination of at least a part of the apparatus of the core network and at least a part of the base station.

A program causing a computer to execute each piece of the processing performed by the communication apparatus (e.g., UE 100 or gNB 200) may be provided. The program may be recorded in a computer-readable medium. Use of the computer-readable medium enables the program to be installed on a computer. Here, the computer-readable medium on which the program is recorded may be a non-transitory recording medium. The non-transitory recording medium is not particularly limited, and may be, for example, a recording medium such as a CD-ROM or a DVD-ROM. Circuits for performing each piece of processing performed by the communication apparatus may be integrated, and at least part of the communication apparatus may be configured as a semiconductor integrated circuit (chipset, System on a chip (SoC)).

The functions achieved by the UE 100 or the gNB 200 (the network node) may be implemented in a circuitry or a processing circuitry programmed to perform the described functions, including a general-purpose processor, a special-purpose processor, an integrated circuit, application specific integrated circuits (ASICs), a central processing unit (CPU), a conventional circuit, and/or combinations thereof. The processor may include transistors and other circuits and may be considered a circuitry or a processing circuitry. The processor may be a programmed processor that executes a program stored in the memory. As used herein, a circuitry, a unit, and means are hardware programmed to achieve, or hardware performing, the described functions. The hardware may be any hardware disclosed herein or any hardware programmed to achieve or known to perform the described functions. When the hardware is a processor that is considered to be a type of circuitry, the circuitry, means, or a unit is a combination of hardware and software used to configure the hardware and/or the processor.

As used in this disclosure, the terms “based on” and “depending on” do not mean “based only on” or “depending only on”, unless otherwise specified. The phrase “based on” means both “based only on” and “based at least in part on”. The phrase “depending on” means both “only depending on” and “at least partially depending on”. “Obtain” or “acquire” may mean to obtain information from stored information, may mean to obtain information from information received from another node, or may mean to obtain information by generating the information. The terms “include,” “comprise” and variations thereof do not mean “include only items stated” but instead mean “may include only items stated” or “may include not only the items stated but also other items.” The term “or” used in the present disclosure is not intended to be “exclusive or”. Any references to elements using designations such as “first” and “second” as used in the present disclosure do not generally limit the quantity or order of those elements. These designations may be used herein as a convenient method of distinguishing between two or more elements. Thus, a reference to first and second elements does not mean that only two elements may be employed there or that the first element needs to precede the second element in some manner. For example, when the English articles such as “a”, “an”, and “the” are added in the present disclosure through translation, these articles include the plural unless clearly indicated otherwise in context.

The embodiments have been described above in detail with reference to the drawings, but specific configurations are not limited to those described above, and various design variation can be made without departing from the gist of the present disclosure.

### (6) Supplementary Notes

Features relating to the embodiments described above are described below as supplementary notes.

### Supplementary Note 1

A communication method performed by a user apparatus in a mobile communication system, the communication method including the steps of:
receiving, from a network node, configuration information for applying inference processing using an artificial intelligence or machine learning (AI/ML) model to wireless communication with the network node; and
performing the wireless communication to which the inference processing is applied, based on the configuration information,
in which the configuration information includes a discontinuous operation configuration for discontinuously applying the inference processing, and
the performing of the wireless communication includes discontinuously applying the inference processing.

### Supplementary Note 2

The communication method according to Supplementary Note 1, in which
the discontinuous operation configuration includes information indicating a timing at which the inference processing is necessary and information indicating a timing at which the inference processing is unnecessary.

### Supplementary Note 3

The communication method according to Supplementary Note 2, in which
the discontinuous operation configuration includes information related to an inference cycle when the inference processing is periodically applied and/or information related to an inference timing at which the inference processing is applied in a single-instance manner.

### Supplementary Note 4

The communication method according to any one of Supplementary Notes 1 to 3, in which the discontinuously applying of the inference includes the steps of:
identifying, based on the discontinuous operation configuration, a timing at which the inference processing is unnecessary; and
stopping the inference processing at the identified timing.

### Supplementary Note 5

The communication method according to any one of Supplementary Notes 1 to 4, in which the receiving includes receiving, from the network node, a Radio Resource Control (RRC) reconfiguration message including the configuration information.

### Supplementary Note 6

The communication method according to any one of Supplementary Notes 1 to 5, in which the configuration information includes identification information for identifying the AI/ML model used for the inference processing.

### Supplementary Note 7

The communication method according to any one of Supplementary Notes 1 to 6, in which the configuration information includes information for configuring that the inference processing is applied to prediction of downlink Channel State Information (CSI), and
the performing of the wireless communication includes applying the inference processing to prediction of the CSI at a timing at which the inference processing is necessary.

### Supplementary Note 8

A communication method performed by a user apparatus in a mobile communication system, the communication method including the steps of:
receiving, from a network node, configuration information for applying inference processing using an artificial intelligence or machine learning (AI/ML) model to wireless communication with the network node;
performing the wireless communication to which the inference processing is applied, based on the configuration information; and
transmitting, to the network node, AI/ML preference information indicating a preference for a configuration change for reducing a processing load of the inference processing.

### Supplementary Note 9

The communication method according to Supplementary Note 8, in which the transmitting includes transmitting, to the network node, a UE Assistance Information message including the AI/ML preference information.

### Supplementary Note 10

The communication method according to Supplementary Note 8 or 9, in which the AI/ML preference information includes a limit value regarding the processing load.

### Supplementary Note 11

The communication method according to any one of Supplementary Notes 8 to 10, in which the AI/ML preference information includes information indicating stopping the inference processing as the preference.

### Supplementary Note 12

The communication method according to any one of Supplementary Notes 8 to 11, further including:
detecting an internal overheating state in the user apparatus,
in which the transmitting includes transmitting, to the network node, the AI/ML preference information depending on detection of the internal overheating state.

### REFERENCE SIGNS

1: Mobile communication system
5: Network
10: RAN (NG-RAN)
20: CN (5GC)
100: UE
110: Receiver
120: Transmitter
130: Controller
131: CSI generator
200: gNB
210: Transmitter
220: Receiver
230: Controller
240: Backhaul communicator
A1: Data collector
A2: Model trainer
A3: Model inferrer
A4: Data processor

1. A communication method performed by a user apparatus in a mobile communication system, the method comprising:
receiving, from a network node, configuration information for applying inference processing using an Artificial Intelligence or Machine Learning (AI/ML) model to wireless communication with the network node; and
performing the inference processing based on the configuration information,
wherein the configuration information includes frequency resource information predicted by the inference processing.

2. The communication method according to claim 1, wherein
the configuration information includes information relating to an inference period in a case where the inference processing is applied periodically,
the information relating the inference period includes a period at which a prediction is performed by the inference processing and a number of times the prediction is performed by the inference processing.

3. A user equipment in a mobile communication system, the user equipment comprising a transceiver circuitry and a processing circuitry operatively associated with the transceiver circuitry and configured to execute processing of:
receiving, from a network node, configuration information for applying inference processing using an Artificial Intelligence or Machine Learning (AI/ML) model to wireless communication with the network node; and
performing the inference processing based on the configuration information,
wherein the configuration information includes frequency resource information predicted by the inference processing.

4. A mobile communication system comprising a user equipment and a network node, wherein
the user equipment is configured to receive, from a network node, configuration information for applying inference processing using an Artificial Intelligence or Machine Learning (AI/ML) model to wireless communication with the network node,
the user equipment is configured to perform the inference processing based on the configuration information, and
the configuration information includes frequency resource information predicted by the inference processing.

5. A non-transitory computer-readable storage medium storing instructions that, when executed by a processor of a user equipment in a mobile communication system, cause the processor to perform the method according to claim 1.

6. A chipset for a user equipment in a mobile communication system, the chipset configured to execute the instructions stored on the non-transitory computer-readable medium of claim 5.
